(19) United States
(12) Patent Application Publication
(10) Pub. No.: US 2011/0174787 A1
(43) Pub. Date: Jul. 21, 2011

(54) LASER DICING APPARATUS

(76) Inventors: Mitsuhiro IDE, Shizuoka (JP); Makoto Hayashi, Kanagawa (JP)

(21) Appl. No.: 13/008,382

(22) Filed: Jan. 18, 2011

(30) Foreign Application Priority Data
Jan. 21, 2010 (JP) 2010-011348

(51) Int. Cl. B23K 26/00

(52) U.S. Cl. 219/121.67

(57) ABSTRACT

A laser dicing device is provided to perform dicing processing that has excellent cutting properties and is stable even when the dicing speed is changed. The laser dicing apparatus includes: a stage; a reference clock oscillation circuit; a laser oscillator that emits a pulse laser beam; a laser oscillator controller that synchronizes the pulse laser beam with the clock signal; a pulse picker that switches irradiation and non-irradiation of the pulse laser beam onto the substrate to be processed; a pulse picker controller that controls pass and interception of the pulse laser beam for each light pulse in synchronization with the clock signal; a processing table unit that stores a processing table in which dicing processing data with respect to a standard relative velocity between the substrate to be processed and the pulse laser beam is written; a velocity input unit that inputs a new set value of a relative velocity; and an operation unit that calculates a new processing table and stores the new processing table into the processing table unit. Based on the new processing table, the pulse picker controller controls pass and interception of the pulse laser beam.

### CROSS-REFERENCE TO RELATED APPLICATION

This application is based on and claims priority of Japanese Patent Application (JPA) No. 2010-011348, filed on Jan. 21, 2010, the entire contents of which are incorporated herein by reference.

### FIELD OF THE INVENTION

The present invention relates to a laser dicing apparatus using a pulse laser beam.

### BACKGROUND OF THE INVENTION

A method that uses a pulse laser beam in dicing of a semiconductor substrate is disclosed in Japanese Patent No. 3867107. According to the method disclosed in Japanese Patent No. 3867107, a pulse laser beam causes optical damage to the inside of an object to be processed, to form a crack region. The object to be processed is cut on the bases of the crack region.

In the conventional art, formation of the crack region is controlled, with parameters being the energy and spot diameter of the pulse laser beam, and the relative movement velocity between the pulse laser beam and the object to be processed.

However, the conventional method has a problem that a crack is formed at an unexpected site, and the formation of the crack cannot be controlled in an adequate manner. Because of this, it is difficult to apply the conventional method to dicing of a substrate made of a hard material such as sapphire, or dicing with small cutting width. Also, when the dicing speed is changed to control productivity, for example, it is difficult to perform stable dicing processing before and after the change in speed.

The present invention has been made in view of the above circumstances, and the object thereof is to provide a laser dicing apparatus that has excellent cutting properties, and realizes stable dicing processing even if the dicing speed is changed.

### SUMMARY OF THE INVENTION

A laser dicing apparatus as an aspect of the present invention includes: a stage on which a substrate to be processed can be mounted; a reference clock oscillation circuit that generates a clock signal; a laser oscillator that emits a pulse laser beam; a laser oscillator controller that synchronizes the pulse laser beam with the clock signal; a pulse picker that switches irradiation and non-irradiation of the pulse laser beam onto the substrate to be processed, the pulse picker being placed in an optical path between the laser oscillator and the stage; a pulse picker controller that controls pass and interception of the pulse laser beam for each light pulse at the pulse picker in synchronization with the clock signal; a processing table unit that stores a processing table in which dicing processing data with respect to a standard relative velocity between the substrate to be processed and the pulse laser beam is written with the numbers of light pulses of the pulse laser beam; a velocity input unit that inputs a set value of a relative velocity between the substrate to be processed and the pulse laser beam; and an operation unit that calculates a new processing table corresponding to the set value and stores the new processing table into the processing table unit, based on the set value and the processing table. Based on the new processing table, the pulse picker controller controls pass and interception of the pulse laser beam at the pulse picker.

In the laser dicing apparatus of the above aspect, the substrate to be processed and the pulse laser beam are preferably moved in relation to each other by moving the stage, and the set value is preferably a set value of a stage velocity.

### BRIEF DESCRIPTION OF THE DRAWINGS

FIG. 1 is a schematic view showing an example structure of a laser dicing apparatus according to an embodiment;

FIG. 2 is a diagram for explaining the timing control according to the laser dicing method using the laser dicing apparatus of the embodiment;

FIG. 3 is a diagram showing the timing of a pulse picking operation and the timing of a modulated pulse laser beam according to the laser dicing method using the laser dicing apparatus of embodiment;

FIG. 4 is a diagram for explaining an irradiation pattern according to the laser dicing method using the laser dicing apparatus of the embodiment;

FIG. 5 is a top view showing an irradiation pattern formed on a sapphire substrate;

FIG. 6 is a cross-sectional view taken along the line A-A of FIG. 5;

FIG. 7 is a diagram for explaining the relationship between movement of the stage and dicing processing;

FIG. 8 is a diagram showing an example of the irradiation pattern; and

FIGS. 9A, 9B, and 9C show an example of specific results of the laser dicing.

### DETAILED DESCRIPTION OF THE INVENTION

Hereinafter, an embodiment of the present invention will be described with reference to the accompanying drawings.

A laser dicing apparatus of this embodiment includes: a stage on which a substrate to be processed can be mounted; a reference clock oscillation circuit that generates a clock signal; a laser oscillator that emits a pulse laser beam; a laser oscillator controller that synchronizes the pulse laser beam with the clock signal; a pulse picker that switches irradiation and non-irradiation of the pulse laser beam onto the substrate to be processed, the pulse picker being placed in an optical path between the laser oscillator and the stage; and a pulse picker controller that controls pass and interception of the pulse laser beam for each light pulse at the pulse picker in synchronization with the clock signal. The laser dicing apparatus further includes: a processing table unit that stores a processing table in which dicing processing data with respect to a standard relative velocity between the substrate to be processed and the pulse laser beam is written with the numbers of light pulses of the pulse laser beam; a velocity input unit that inputs a set value of a relative velocity between the substrate to be processed and the pulse laser beam; and an operation unit that calculates a new processing table corresponding to the set value and stores the new processing table into the processing table unit, based on the set value and the processing table. Based on the new processing table, the pulse picker controller controls pass and interception of the pulse laser beam at the pulse picker.

Having the above described structure, the laser dicing apparatus of this embodiment has excellent cutting properties, and performs dicing processing that is stable even when the dicing speed is changed. That is, even when the relative velocity between the substrate to be processed and the pulse laser beam is changed so as to control productivity, almost the same dicing processing shape is always obtained.

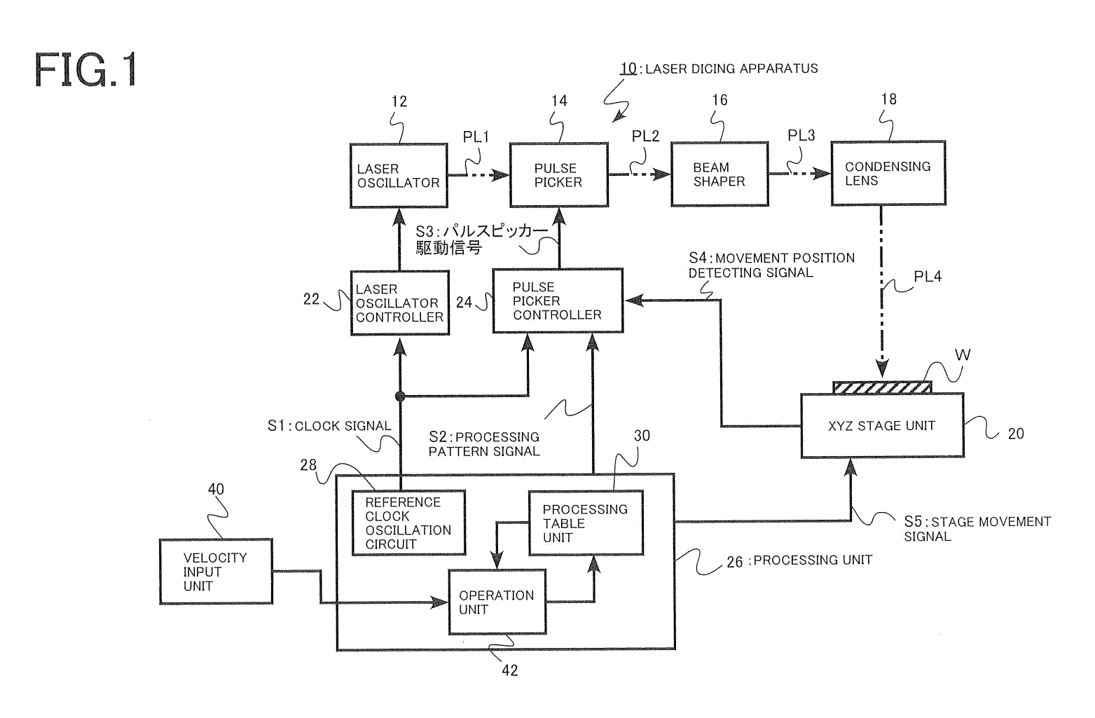

FIG. 1 is a schematic view showing an example structure of a laser dicing apparatus according to this embodiment. As shown in FIG. 1, the laser dicing apparatus 10 according to this embodiment includes a laser oscillator 12, a pulse picker 14, a beam shaper 16, a condensing lens 18, an XYZ stage unit 20, a laser oscillator controller 22, a pulse picker controller 24, and a processing controller 26 as main components. The processing controller 26 includes a reference clock oscillation circuit 28 that generates a desired clock signal S1, processing table unit 30, and an operation unit 42. The laser dicing apparatus 10 further includes a velocity input unit 40 that inputs the set value of the relative velocity between the substrate to be processed and a pulse laser beam.

The laser oscillator 12 is designed to emit a pulse laser beam PL1 with a cycle Tc that is synchronized with the clock signal S1 generated by the reference clock oscillation circuit 28. The strength of the emitted pulse light indicates a Gaussian distribution.

The wavelength of the laser beam emitted from the laser oscillator 12 here has light transmission properties with respect to the substrate to be processed. The pulse laser beam that is output from the laser oscillator 12 has a fixed frequency and irradiation energy (irradiation power). The lasers that may be used include a Nd: YAG laser, a Nd:YVO₄ laser, and a Nd:YLF laser. For example, when the substrate to be processed is a sapphire substrate, it is preferable to use a Nd:YVO₄ laser with a wavelength of 532 nm.

To allow the dicing processing speed to have a higher degree of freedom, the fixed frequency is preferably as high as possible, such as 100 KHz or higher.

The pulse picker 14 is provided on an optical path between the laser oscillator 12 and the condensing lens 18. The pulse picker 14 is designed to switch pass and interception (ON/OFF) of the pulse laser beam PL1 in synchronization with the clock signal S1, to switch irradiation and non-irradiation of the pulse laser beam PL1 onto the substrate to be processed for each light pulse. Through this operation of the pulse picker 19, switching on and off of the pulse laser beam PL1 is controlled to process the substrate to be processed, and the resultant pulse laser beam is a modulated pulse laser beam PL2.

The pulse picker 14 is preferably formed by an acousto-optical modulator (AOM), for example. Alternatively, the pulse picker 14 may be formed by an electro-optical modulator (EOM) of a Raman diffraction type.

The beam shaper 16 shapes the incident pulse laser beam PL2 into a desired shape to generate a pulse laser beam PL3. For example, the beam shaper 16 is a beam expander that expands the beam diameter at a fixed magnification. The beam shaper 16 may include an optical element, such as a homogenizer that causes the light strength in a beam section to be distributed uniformly. The beam shaper 16 may also include an optical element that shapes a beam section into a circular shape or an optical element that converts a beam into circularly polarized light, for example.

The condensing lens 18 is designed to condense the pulse laser beam PL3 shaped by the beam shaper 16 and irradiates a substrate W that is to be processed and is placed on the XYZ stage unit 20, such as a sapphire substrate having LEDs formed on its bottom surface, with a pulse laser beam PL4.

The XYZ stage unit 20 includes an XYZ stage (hereinafter, also referred to simply as the stage) that can have the substrate W to be processed mounted thereon and freely move in the XYZ directions, a driving mechanism unit, and a position sensor that has a laser interferometer to measure the position of the stage, for example. In this case, the XYZ stage is designed with such high precision that the positioning accuracy and the movement error fall within a submicron range.

The velocity input unit 40 is designed to allow an operator or the like to input a set value of a stage velocity that is higher or lower than a standard stage velocity when productivity is to be made higher, for example. The velocity input unit 40 is an input terminal with a keyboard, for example.

The processing controller 26 controls the entire processing performed by the laser dicing apparatus 10. The reference clock oscillation circuit 28 generates a desired clock signal S1. The processing table unit 30 stores a processing table in which dicing processing data relative to the standard stage velocity is written with the numbers of light pulses of pulse laser beams. In the processing table, a combination of the number of light pulses for performing laser beam irradiation (the number of irradiation light pulses) and the number of light pulses for not performing irradiation (the number of non-irradiation light pulses) is written.

The operation unit 42 has the function to calculate a new processing table corresponding to a set value of a new stage velocity and store the new processing table into the processing table unit, based on the set value of the new stage velocity and the processing table input from the velocity input unit 40. At this point, the processing table is created so that the dicing processed shape remaining almost the same before and after the change of the stage velocity.

The dicing processing data relative to the standard stage velocity is overwritten. If the set value of the input new stage velocity is the same as the standard stage velocity, a new processing table is not calculated.

Referring now to FIGS. 1 through 7, the laser dicing method using the above described laser dicing apparatus 10 is described.

According to the laser dicing method using the laser dicing apparatus 10 of this embodiment, the substrate to be processed is placed on the stage, and the clock signal is generated. The pulse laser beam is emitted in synchronization with the clock signal, and the substrate to be processed and the pulse laser beam are moved relative to each other. Irradiation and non-irradiation of the pulse laser beam onto the substrate to be processed are switched for each light pulse by controlling pass and interception of the pulse laser beam in synchronization with the clock signal. In this manner, a crack region that reaches the substrate surface is formed on the substrate to be processed. Further, the processing table is rewritten, and pass and interception of the pulse laser beam are controlled in accordance with a relative velocity that is input about the substrate to be processed and the pulse laser beam, so that almost the same dicing shapes can be realized.

With the above arrangement, irradiation and non-irradiation of the pulse laser beam onto the substrate to be processed can be accurately performed in optimum proportion. Accordingly, formation of cracks that reach the substrate surface is controlled, and the crack region is stabilized. Thus, optimum shapes can be formed. In this manner, a laser dicing method that realizes excellent cutting properties can be provided. Also, even if the dicing speed is changed, stable dicing processing can be performed.

First, a laser dicing method to be implemented at the standard stage velocity is described.

First, a substrate W to be processed, such as a sapphire substrate, is placed on the XYZ stage unit 20. This sapphire substrate is a wafer that has a GaN layer epitaxially grown on its lower face, and has LEDs formed as a pattern on the GaN layer. The wafer is positioned, to the XYZ stage, with reference to notches or an orientation flat formed in the wafer.

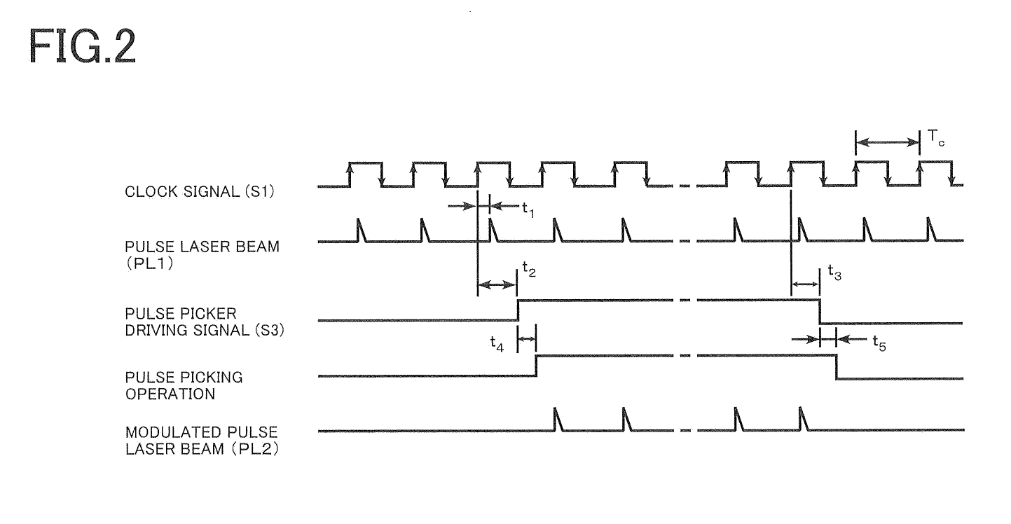

FIG. 2 is a diagram for explaining the timing control according to the laser dicing method of this embodiment. At the reference clock oscillation circuit 28 in the processing controller 26, the clock signal S1 with a cycle Tc is generated. The laser oscillator controller 22 controls the laser oscillator 12 to emit the pulse laser beam PL1 with the cycle Tc synchronized with the clock signal S1. At this point, there is a delay time t₁ between a rising edge of the clock signal S1 and a rising edge of the pulse laser beam.

The laser beam used here has a wavelength that exhibits light transmission properties with respect to the substrate to be processed. In this case, it is preferable to use a laser beam having a greater energy hν of the photons of the laser beam irradiating than the absorption bandgap Eg of the material of the substrate to be processed. If the energy hν is very much greater than the bandgap Eg, the laser beam is absorbed. This is called multiple photon absorption. If the pulse width of the laser beam is made extremely small to cause multiple photon absorption in the substrate to be processed, the energy of the multiple photon absorption is not transformed into thermal energy. Instead, a permanent structural change, such as anion valence change, crystallization, amorphousness, polarization of orientation, or formation of minute cracks, is induced, and a refractive-index-changed region (a color center) is formed.

If a wavelength with light transmission properties is used for the material of the substrate to be processed, the laser beam can be guided and condensed in the vicinity of the focal point of an inner portion of the substrate. Accordingly, the refractive-index-changed region can be locally processed. Hereinafter, the refractive-index-changed region is called the modified region.

The pulse picker controller 24 refers to a processing pattern signal S2 that is output from the processing controller 26, and generates a pulse picker driving signal S3 that is synchronized with the clock signal S1. The processing pattern signal. S2 is stored in the processing table unit 30, and is generated with reference to the processing table in which the information about the irradiation pattern is written with the numbers of light pulses for each light pulse. The pulse picker 14 switches pass and interception (ON/OFF) of the pulse laser beam PL1 in synchronization with the clock signal S1, based on the pulse picker driving signal S3.

Through the operation of this pulse picker 14, the modulated pulse laser beam PL2 is generated. It should be noted that there are delay times t₂ and t₃ between a rising edge of the clock signal S1 and rising and falling edges of the pulse laser beam. Also, there are delay times t₄ and t₅ between rising and falling edges of the pulse laser beams and the pulse picking operation.

When the substrate to be processed is processed, the timing of generation of the pulse picker driving signal S3 and the like, and the timing of relative movement between the substrate to be processed and the pulse laser beam are determined, with the delay times t₁ through t₅ being taken into account.

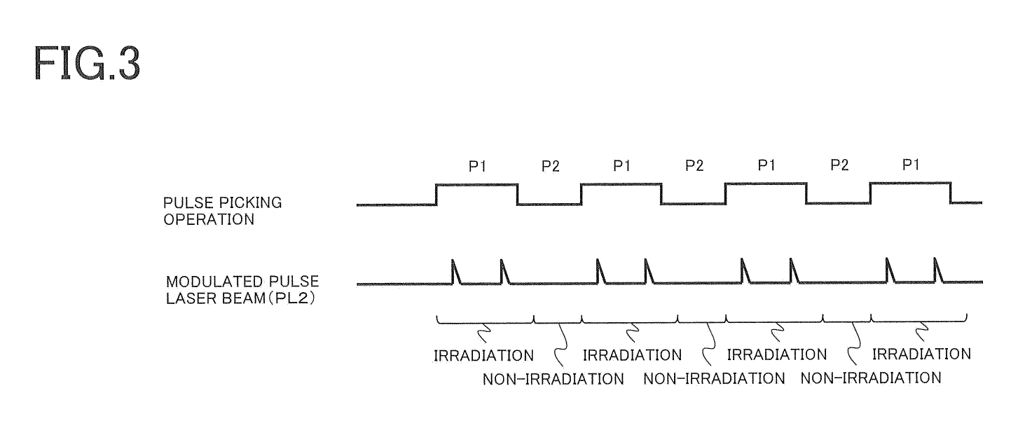

FIG. 3 is a diagram showing the timing of the pulse picking operation and the timing of the modulated pulse laser beam PL2 according to the laser dicing method of this embodiment. The pulse picking operation is switched for each light pulse in synchronization with the clock signal S1. As the oscillation of the pulse laser beam and the pulse, picking operation are synchronized with the same clock signal S1 in the above manner, an irradiation pattern based on each light pulse can be realized.

Specifically, irradiation and non-irradiation of the pulse laser beam are performed under predetermined conditions defined by the number of light pulses. That is, the pulse picking operation is performed based on the number of irradiation light pulses (P1) and the number of non-irradiation light pulses (P2), so that irradiation and non-irradiation onto the substrate to be processed are switched. A P1 value and a P2 value that define the irradiation pattern of the pulse laser beam are set as the irradiation region register setting and the non-irradiation region register setting in the processing table, for example. The P1 value and the P2 value are set in predetermined conditions that optimize the formation of cracks at the time of dicing, depending on the material of the substrate to be processed and the condition of the laser beam.

The modulated pulse laser beam PL2 is turned into the pulse laser beam PL3 shaped into a desired form by the beam shaper 16. Further, the shaped pulse laser beam PL3 is condensed by the condensing lens 18, and is turned into the pulse laser beam PL4 having a desired beam diameter. The wafer that is the substrate to be processed is then irradiated with the pulse laser beam PL4.

When the wafer is to be diced in the X-axis direction and the Y-axis direction, the XYZ stage is first moved in the X-axis direction at a constant velocity, and is scanned with the pulse laser beam PL4. After the desired dicing in the X-axis direction is finished, the XYZ stage is moved in the Y-axis direction at a constant velocity, and is scanned with the pulse laser beam PL4. In this manner, the dicing in the Y-axis direction is performed.

In the Z-axis direction (the height direction), the focal position of the condensing lens is adjusted to a desired depth in the wafer. The desired depth is set so that cracks are formed in desired shapes at the time of dicing.

At this point, the relationship, Lz=L/n, is established,

where n represents the refractive index of the substrate to be processed,

L represents the processing position from the surface of the substrate to be processed, and

Lz represents the length of the movement in the Z-axis direction. That is, in a case where the surface of the substrate to be processed is set as the Z-axis initial position, and processing is performed at the location of the depth “L” from the substrate surface, the position of the light condensing performed by the condensing lens should be moved in the Z-axis direction by “Lz”.

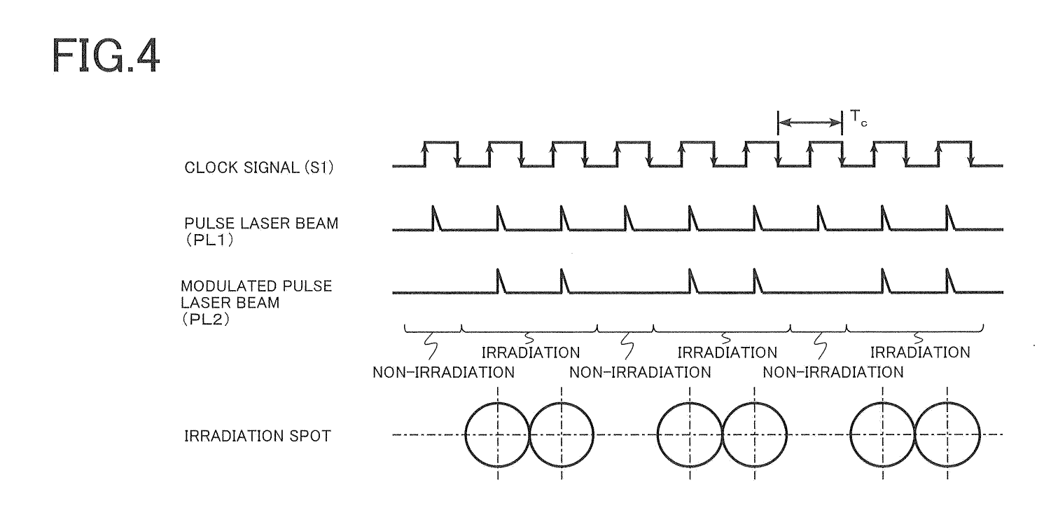

FIG. 4 is a diagram for explaining the irradiation pattern according to the laser dicing method of this embodiment. As shown in the drawing, the pulse laser beam PL1 is generated in synchronization with the clock signal S1. Pass and interception of the pulse laser beam are then controlled in synchronization with the clock signal S1, to generate the modulated pulse laser beam PL2.

By moving the stage in the horizontal direction (the X-axis direction or the Y-axis direction), the irradiation light pulses of the modulated pulse laser beam PL2 are formed as irradiation spots on the wafer. As the modulated pulse laser beam PL2 is generated in this manner, the irradiation spots are controlled for each light pulse and are intermittently formed on the wafer. In the example case illustrated in FIG. 4, the number of irradiation light pulses (P1) is 2, and the number of non-irradiation light pulses (P2) is 1. Such conditions are set that the irradiation light pulses (Gaussian light) repeat irradiation and non-irradiation at the pitch equivalent to the spot diameter.

Where D represents the beam spot diameter (μm) and

F represents the recurrence frequency (KHz),

the irradiation light pulses repeat irradiation and non-irradiation at the pitch equivalent to the spot diameter when processing is performed. Accordingly, the moving velocity V (m/sec) of the stage is expressed as: V=D×10⁻⁶×F×10³.

For example, if the processing conditions specify that the beam spot diameter D is 2 μm, and

the recurrence frequency F is 50 KHz,

the moving velocity V of the stage is 100 mm/sec.

If the power of irradiation light is P (watt), the wafer is irradiated with light pulses of an irradiation pulse energy per pulse P/F.

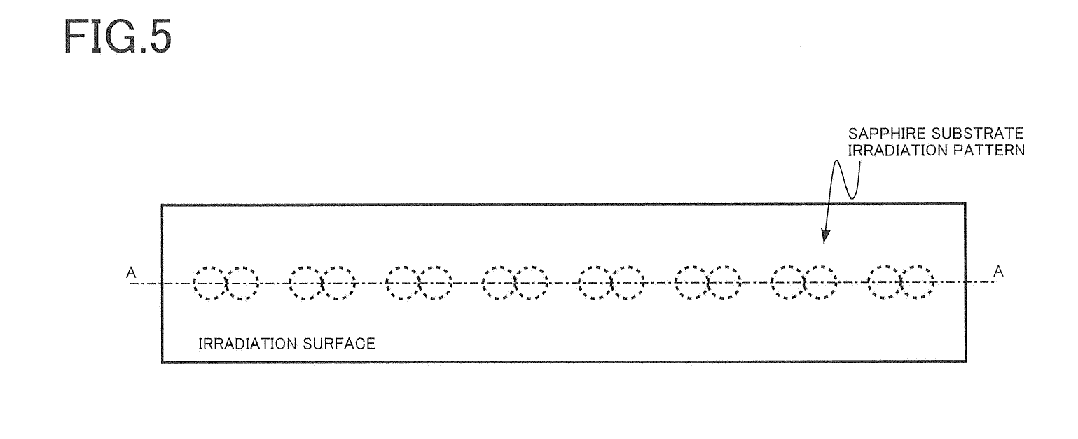

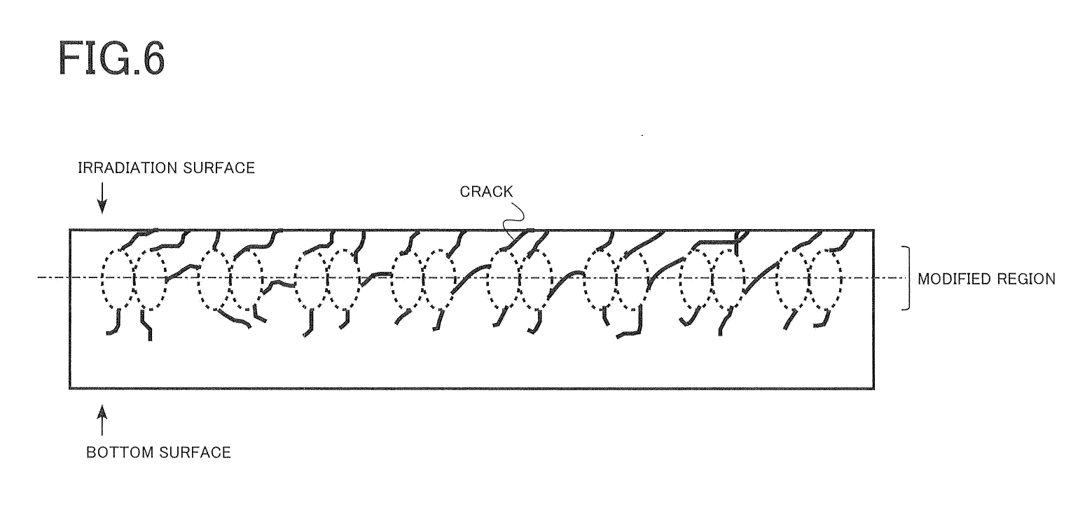

FIG. 5 is a top view showing an irradiation pattern formed on a sapphire substrate. When viewed from above the irradiation surface, irradiation spots are formed at the pitch equivalent to the irradiation spot diameter, with the number of irradiation light pulses (P1) being 2, the number of non-irradiation light pulses (P2) being 1. FIG. 6 is a cross-sectional view taken along the line A-A of FIG. 5. As shown in the drawing, a modified region is formed in the sapphire substrate. Cracks that extend from the modified region and reach the substrate surface along the scanning line of light pulses are formed. The cracks are joined together on the surface of the substrate to be processed, and form an almost straight line.

As the cracks that reach the substrate surface are formed, the cutting of the substrate to be later performed becomes easier. Accordingly, the dicing costs can be lowered. The final cutting of the substrate after the formation of the cracks, or the dividing of the substrate into individual LED chips, may be either spontaneous dividing of the substrate after the formation of the cracks, or dividing performed upon further application of a human-induced force.

By a method of irradiating a substrate continuously with a pulse laser beam as in conventional cases, it is difficult to control the formation of cracks reaching the substrate surface so that the cracks have desired shapes, even if the moving velocity of the stage, the aperture size of the condensing lens, the power of irradiation light, and the like are optimized. In this embodiment, the irradiation pattern is optimized by intermittently switching irradiation and non-irradiation of the pulse laser beam for each light pulse. Accordingly, the formation of the cracks that reach the substrate surface is controlled, and a laser dicing method with excellent cutting properties is provided.

That is, cracks with small widths can be linearly formed along the scanning line of the laser on the substrate surface, for example. Accordingly, the influence of the cracks on devices such as the LEDs formed on the substrate can be minimized at the time of dicing. Also, since the cracks can be linearly formed, the region on the substrate surface in which the cracks are formed can be made narrower. Accordingly, the dicing width can be made smaller, in terms of designing. Thus, the number of chips of devices formed on the same substrate or wafer can be made larger, which contributes to a reduction of the device manufacturing costs.

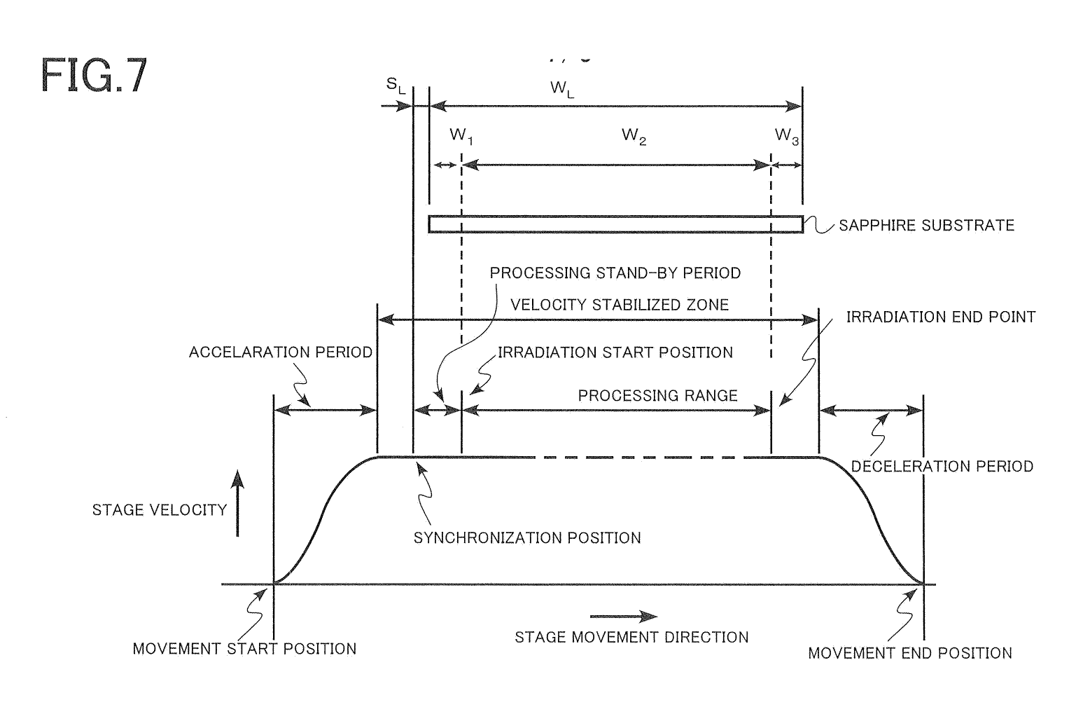

FIG. 7 is a diagram for explaining the relationship between movement of the stage and dicing processing. In the XYZ stage, a position sensor that detects movement positions in the X- and Y-axis directions is provided. For example, the position where the stage velocity enters a velocity stabilized zone after the stage starts moving in the X- or Y-axis direction is set beforehand as the synchronization position. When the position sensor detects the synchronization position, a pulse picking operation is allowed by a movement position detection signal S4 (see FIG. 1) transmitted to the pulse picker controller 24, and the pulse picker is activated by the pulse picker driving signal S3.

In this manner,

the distance S_{L} from the synchronization position to the substrate,

the processing length W_{L},

the distance W₁ from a substrate end to the irradiation start position,

the processing range W₂, and

the distance W₃ from the irradiation end position to the substrate end are managed.

In the above described manner, the stage position and the operation start position of the pulse picker are synchronized with each other. That is, irradiation and non-irradiation of the pulse laser beam are synchronized with the position of the stage. Accordingly, when irradiation and non-irradiation with the pulse laser beam are performed, it is ensured that the stage moves at a constant velocity (or stays within the velocity stabilized zone). Accordingly, the regularity of the positions of the irradiation spots is guaranteed, and stable formation of the cracks is realized.

Also, to further increase the precision of the positions of the irradiation spots, movement of the stage is preferably synchronized with the clock signal, for example. This can be realized by synchronizing a stage movement signal S5 (see FIG. 1) transmitted from the processing controller 26 to the XYZ stage unit 20 with the clock signal S1, for example.

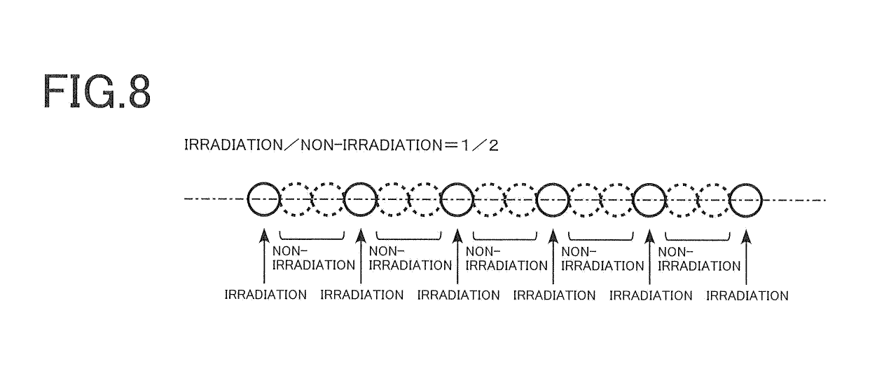

FIG. 8 is a diagram showing a specific example of the irradiation pattern. As shown in the drawing, after irradiation with a light pulse is performed once, irradiation is not performed for the duration equivalent to two light pulses. Those conditions will be hereinafter referred to as the format of “irradiation/non-irradiation=½”. The pitch of irradiation and non-irradiation here is equivalent to the spot diameter.

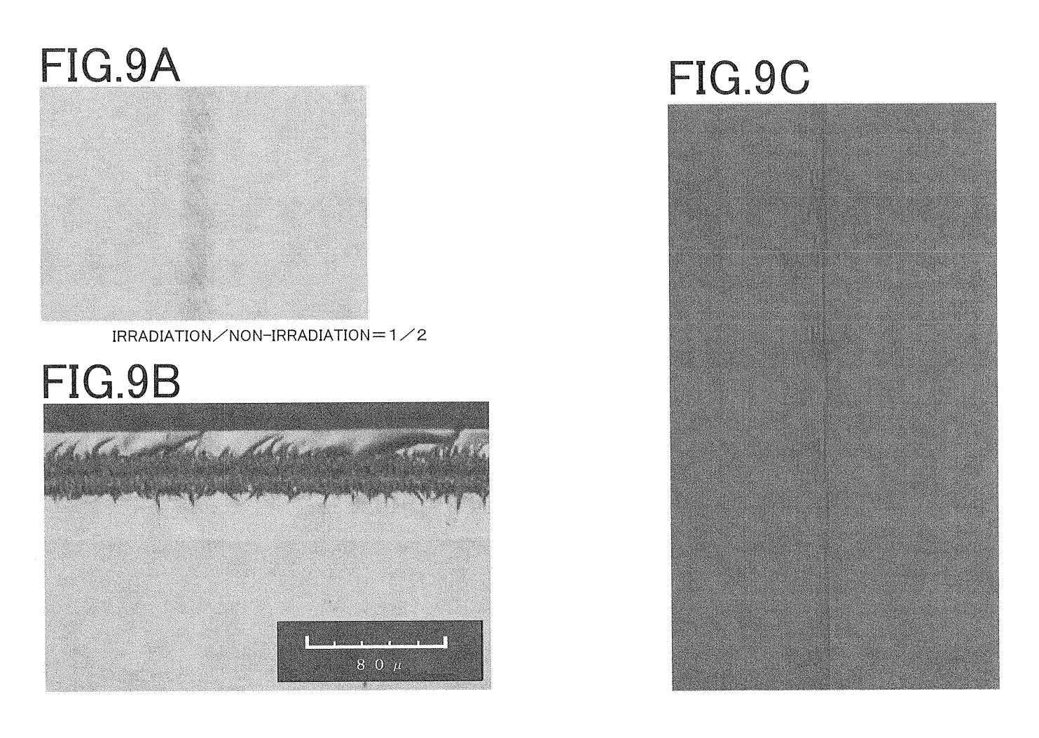

FIGS. 9A through 9C show specific results of the laser dicing. FIG. 9A shows a photograph of the top surface of the substrate. FIG. 9B shows a photograph of the top surface of the substrate taken at a lower magnification than that of FIG. 9A. FIG. 9C is a photograph of a section taken along the dicing direction of the substrate.

The laser dicing conditions in this specific example are as follows:

the substrate to be processed is a sapphire substrate;

the laser beam source is a Nd:YVO₄ laser;

the wavelength is 532 nm;

the number of irradiation light pulses (P1) is 1, and

the number of non-irradiation light pulses (P2) is 2.

As is apparent from the photograph of the section shown in FIG. 9C, a crack that extends from the modified region in the substrate and reaches the substrate surface is formed. As is apparent from the photograph shown in FIG. 9A, a crack that has a relatively linear shape and has a small width is formed in the top surface of the substrate.

As described above, when laser dicing is performed by switching irradiation and non-irradiation of the pulse laser beam for each optical pulse, formation of cracks is controlled by optimizing the irradiation pattern, and excellent cutting properties can be achieved.

Next, a laser dicing method to be implemented in a case where the stage velocity is changed from the standard stage velocity is described. To increase productivity, an operator inputs a set value of a higher stage velocity than the standard stage velocity to the velocity input unit 40 shown in FIG. 1, for example. Based on the set value of the new stage velocity input from the velocity input unit 40 and the processing table, the operation unit 42 calculates a new processing table according to the set value of the new stage speed.

For example, the conditions for processing at the standard stage velocity are as follows.

Recurrence frequency F: 500 KHz

Number of irradiation light pulses (P1): 1

Number of non-irradiation light pulses (P2): 9

Moving velocity V of the stage: 200 mm/sec

In a case where the moving velocity V of the stage is doubled to 400 mm/sec so as to increase productivity, the operation unit 42 that receives an input of the set value calculates such a processing table that almost the same dicing processing shape as that in the case of the standard velocity can be obtained. Specifically, the number of irradiation light pulses (P1) and the number of non-irradiation light pulses (P2) are determined so that the intervals between the irradiation light pulses become almost equal to the intervals between the non-irradiation light pulses.

In the case of this example, the number of irradiation light pulses (P1) is 1, and

the number of non-irradiation light pulses (P2) is 4.

In a case where the moving velocity V of the stage is halved to 100 mm/sec so as to lower productivity, on the other hand, the operation unit 42 that receives an input of the set value calculates such a processing table that almost the same dicing processing shape as that in the case of the standard velocity can be obtained. The case where productivity is to be lowered is a case where only the stage velocity is to be lowered without a stop of the apparatus, so as to maintain the thermal stability of the apparatus, for example, while lowering productivity.

In the case of this example, the number of irradiation light pulses (P1) is 1, and

the number of non-irradiation light pulses (P2) is 19.

In this manner, the previous processing table is overwritten with the new processing table obtained by the operation unit 42, and the new processing table is stored into the processing table unit. Based on the new processing table, the pulse picker controller 24 controls pass and interception of the pulse laser beam at the pulse picker 14. With this arrangement, even if the stage velocity is changed, almost the same dicing processing shape as that in the case of the standard velocity can be obtained.

As described above, with the laser dicing apparatus of this embodiment, dicing processing that has excellent cutting properties and is stable even when the dicing speed is changed can be performed. While the recurrence frequency, irradiation energy, and focal position of the pulse laser beam are fixed, the intervals between irradiation and non-irradiation of light pulses are calculated and are matched with each other. Therefore, there is no need to change any other parameters. Accordingly, the same dicing processing shape is still obtained even when the processing speed is changed.

An embodiment of the present invention has been described so far, with reference to specific examples. However, the present invention is not limited to those specific examples. In the laser dicing apparatus and the laser dicing method of the embodiment, the components and aspects that are not absolutely necessary in the description of the present invention are not described. However, any necessary elements related to the laser dicing apparatus and the laser dicing method can be arbitrarily selected and used.

For example, in the above described embodiment, the substrate to be processed is a sapphire substrate having LEDs formed thereon. A substrate that is difficult to cut due to its hardness, such as a sapphire substrate, is useful in the present invention, but the substrate to be processed may be a semiconductor substrate such as a SiC (silicon carbide) substrate, or a piezoelectric substrate, a glass substrate, or the like.

In the above described embodiment, the substrate to be processed and the pulse laser beam are moved in relation to each other by moving the stage. With the apparatus and the method, however, a laser beam scanner may be used to perform scanning with the pulse laser beam, for example. By doing so, the substrate to be processed and the pulse laser beam are moved in relation to each other.

Also, in one of the example described in the above embodiment, the number of irradiation light pulses (P1) is 2, and the number of non-irradiation light pulses (P2) is 1. However, the values of P1 and P2 may be any values to optimize conditions. In the above embodiment, irradiation light pulses repeat irradiation and non-irradiation at the pitch equivalent to the spot diameter. However, the pulse frequency or the moving velocity of the stage may be changed to vary the pitch of irradiation and non-irradiation, and obtain optimum conditions. For example, the pitch of irradiation and non-irradiation can be made 1/n of the spot diameter or n times larger than the spot diameter.

As for the dicing processing pattern, various dicing patterns can be coped with by preparing irradiation region registers and non-irradiation region registers, or changing the values of an irradiation region register and a non-irradiation region register to desired values at a desired timing in real time, for example.

Other than the above, all laser dicing apparatuses that include the components of the present invention and can be arbitrarily modified by those skilled in the art are within the scope of the invention. The scope of the invention is defined by the claims and their equivalents.

What is claimed is:

1. A laser dicing apparatus comprising:
a stage on which a substrate to be processed is mounted;
a reference clock oscillation circuit that generates a clock signal;
a laser oscillator that emits a pulse laser beam;
a laser oscillator controller that synchronizes the pulse laser beam with the clock signal;
a pulse picker that switches irradiation and non-irradiation of the pulse laser beam onto the substrate to be processed, the pulse picker being placed in an optical path between the laser oscillator and the stage;
a pulse picker controller that controls pass and interception of the pulse laser beam for each light pulse at the pulse picker in synchronization with the clock signal;
a processing table unit that stores a processing table in which dicing processing data with respect to a standard relative velocity between the substrate to be processed and the pulse laser beam is written with the numbers of light pulses of the pulse laser beam;
a velocity input unit that inputs a set value of a relative velocity between the substrate to be processed and the pulse laser beam; and
an operation unit that calculates a new processing table corresponding to the set value and stores the new processing table into the processing table unit, based on the set value and the processing table; wherein
the pulse picker controller configured to control pass and interception of the pulse laser beam at the pulse picker, based on the new processing table.

2. The laser dicing apparatus according to claim 1, wherein the substrate to be processed and the pulse laser beam are moved in relation to each other by moving the stage, and the set value is a set value of a stage velocity.

3. The laser dicing apparatus according to claim 1, wherein each of the processing table and the new processing table is written with a combination of the number of light pulses for performing irradiation with the laser beam and the number of light pulses for not performing irradiation.

4. The laser dicing apparatus according to claim 1, wherein the operation unit calculates the new processing table, to obtain the same dicing processing shape as that in a case where dicing processing is performed on the substrate to be processed at the standard relative velocity.

5. The laser dicing apparatus according to claim 1, wherein the pulse picker is one of an acousto-optical modulator and an electro-optical modulator.
